(19) United States
(12) Patent Application Publication
(10) Pub. No.: US 2004/0193716 A1
(43) Pub. Date: Sep. 30, 2004

(54) Client distribution through selective address resolution protocol reply

(76) Inventor: Daniel Raymond McConnell, Round Rock, TX (US)

Correspondence Address: HAMILTON & TERRILE, LLP, P.O. BOX 203518, AUSTIN, TX, 78720, US

(21) Appl. No.: 10/404,892

(22) Filed: Mar. 31, 2003

(51) Int. Cl. G06F 15/16

(52) U.S. Cl. 709/228

(57) ABSTRACT

A method and apparatus that enables client-to-server bindings to be modified and controlled automatically and enables data access nodes to be configured to automatically redistribute access. In one embodiment, the redistribution is accomplished using a pool internet protocol (IP) addressing format wherein each of the clients access data via a pool IP address. The pool IP address corresponds to a group of servers that operate in accordance with an algorithm to determine which specific server will respond to the request. An address resolution protocol (ARP) to is used to associate specific media access control (MAC) address with specific servers that respond to a request. Each of the servers in the pool maintains a database, or client service table, of clients that they service. The client service tables can be pre-populated with clients or can be set up with an algorithm to assign servers as they make their requests. When the servers in the pool detect a broadcasted ARP request to the pool IP address, they check their client service tables to determine if the request originates from a client that they service. If the client service table indicates that the designated client is contained in a specific server's client service table, that server responds by sending an ARP response with the server's MAC address back to the designated client. The client is then “bound” to the desired server in the pool and its subsequent requests will be sent to that specific server.

### BACKGROUND OF THE INVENTION

1. Field of the Invention

Present invention relates generally to information system networks. More specifically, the present invention provides an improved method and apparatus for distributing and redistributing client access across multiple access nodes in a network without the need to manually remap the clients.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In many networking systems, virtual file systems and shared file systems allow a consistent view of data across multiple front-end data access devices to allow the same data to be accessed by clients from any one of the multiple front-end data access nodes, typically through a remote file system interface such as CIFS or NFS. In such a configuration, clients must be assigned (“mapped”) to a single, specified server. For both performance and scaling reasons, it is advantageous to be able to modify these client-to-server bindings to balance workloads among the front-end data access nodes. For example, a system that contains 100 host machines mapped evenly to 2 data access nodes (50 to 1 and 50 to the other) may not be providing enough bandwidth. The system administrator can add (or provision) a new data access node to service this storage pool to increase bandwidth. In order to make use of the new data access node, however, the administrator would need to manually reconfigure the mappings on the hosts to redistribute the access evenly.

In most current network configurations, the administrator manually remaps selected clients or adds software to all the clients to implement the remapping in an automated fashion. These methods are generally undesirable since the number of clients in most environments can be very large and the process of manually remapping a large number of clients is obviously cost and time prohibitive. Moreover, the necessity of installing and maintaining software elements on a large number of information handling systems creates other complications, such as the need to support and maintain multiple versions of multiple operating systems that must interact with the mapping software.

Microsoft's DFS is an example of having a client-side agent for remapping of clients to NAS devices. However DFS has significant limitations in that it is a proprietary Microsoft only solution that only works for the CIFS protocol and can be difficult to manage.

In view of the shortcomings of the prior art, there is a need for a method and apparatus that allows client access to be redistributed without the need to actually remap the clients, thereby eliminating the need for manual remapping of clients or additional client-resident code to automate the mapping/re-mapping.

### SUMMARY OF THE INVENTION

The method and apparatus of the present invention enables client-to-server bindings to be modified and controlled automatically by the servers without adding any client-side code. In one embodiment of the present invention, the servers that function as data access nodes are configured to automatically redistribute access without the need for an administrator to intervene to manually reconfigure every client. The redistribution is accomplished using an internet protocol (IP) addressing format wherein each of the clients obtain access to data via a pool IP address. The pool IP address does not directly correspond to a single server but, rather, corresponds to a group of servers that operate in accordance with an algorithm to determine which specific server will respond to the request.

The Address Resolution Protocol (ARP) is used to associate the pool IP address with the specific media access control (MAC) address of specific servers that will respond to a request. Each of the servers in the pool maintains a database, or client service table, of clients that they service. The client service tables can be pre-populated with clients or can be set up with an algorithm to assign servers as clients make their requests.

When the servers in the pool see a broadcasted ARP request to the pool IP address, they check their client service tables to determine if the request originates from a client that they service. If the client service table indicates that the designated client is contained in a specific server's client service table, that server responds by sending an ARP response with the server's MAC address back to the designated client. The client is then “bound” to the desired server in the pool and its subsequent requests will be sent to that specific server. The ARP protocol used in the present invention operates below the network layer as a part of the OSI link layer and has the advantage of providing a solution that is independent of specific software and platforms.

Using the method and apparatus of the present invention, clients can be easily redistributed to different servers by modifying the client service table on the various servers to control the load on each individual server. The present invention also provides a method and apparatus that allows the servers to continually monitor utilization levels, to communicate with one another to determine the most beneficial distribution of clients, and to modify their tables to redistribute the clients.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of the major components of an information system of the type employed in the present invention;

FIG. 2A is an illustration of a network of multiple clients and servers using a pool internet protocol (IP) addressing system;

FIG. 2B is an illustration the network of multiple clients and servers using a pool internet protocol (IP) addressing system shown in FIG. 2A, further illustrating automatic redistribution of servicing load among the servers in the network in accordance with the present invention;

FIG. 3 is a flowchart illustration of processing steps implemented by the various network servers in the present invention for host redistribution using address resolution protocol; and

FIG. 4 is a flowchart illustration of processing steps implemented by the various network clients in the present invention for host redistribution using address resolution protocol.

### DETAILED DESCRIPTION

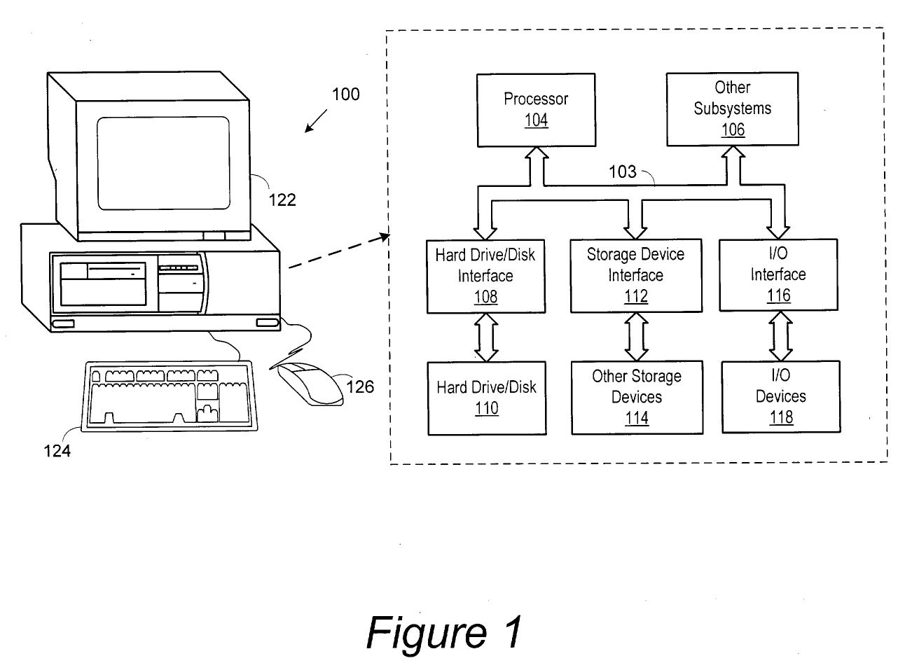

The method and apparatus of the present invention provides significant improvements in the operation of networks comprising information systems such as the information handling system 100 illustrated in FIG. 1. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring to FIG. 1, the information handling system 100 includes a processor 104 and various other subsystems 106 understood by those skilled in the art. Data is transferred between the various system components via various data buses illustrated generally by bus 103. A hard drive 110 is controlled by a hard drive/disk interface 108 that is operably connected to the hard drive/disk 110. Likewise, data transfer between the system components and other storage devices 114 is controlled by storage device interface 112 that is operably connected to the various other storage devices 114, such as CD ROM drives, floppy drives, etc. An input/output (I/O) interface 116 controls the transfer of data between the various system components and a plurality of input/output (I/O) devices 118, such as a display 122, a keyboard 124, a mouse 126.

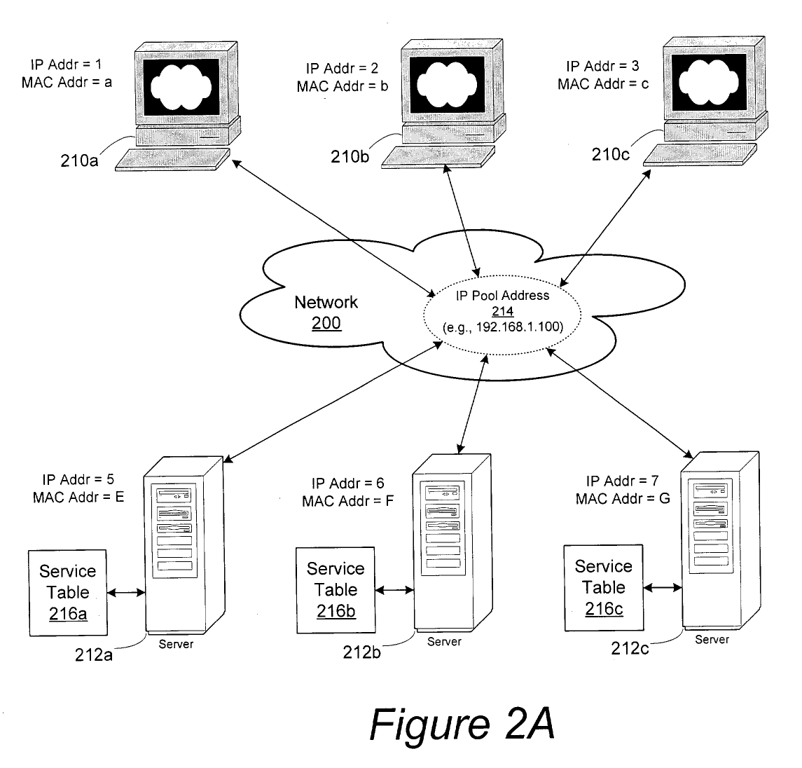

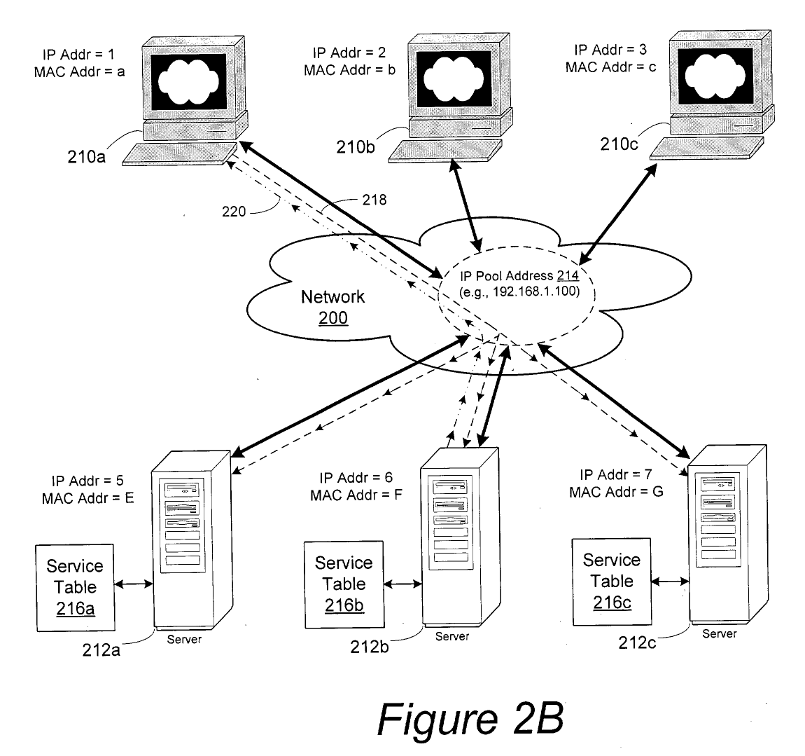

FIG. 2A is an illustration of a network of multiple clients and servers wherein a pool IP address configuration is used in accordance with the present invention to map clients to the pool of servers. The clients are illustrated generally by clients 210a, 210b, and 210c, although the network can be expanded to include any number of clients. Likewise, the servers are illustrated by servers 212a, 212b, and 212c, although the network can be expanded to include any number of servers. Each of the servers 212a, 212b, and 212c has an associated client service table that designates which clients a particular server is responsible for serving. These service tables are illustrated in FIG. 2A by client service tables 216a, 216b, and 216c, which are associated with servers 212a, 212b, and 212c, respectively.

As will be understood by those of skill in the art, the network illustrated in FIG. 2A can be implemented using internet protocol (IP), which is a virtual addressing scheme that is independent of the underlying physical network and is the addressing basis for the internet. Each of the clients 210a, 210b, and 210c and each of the servers 212a, 212b, and 212c illustrated in FIG. 2A have IP addresses. In addition, each of the clients 210a, 210b, and 210c and each of the servers 212a, 212b, and 212c illustrated in FIG. 2A have a media access control (MAC) address that designates a specific address used by the actual physical network to transfer data across the physical network from one information system to another information system.

Address resolution protocol (ARP) is a protocol used by the Internet Protocol (IP) network layer to map IP network addresses to the hardware addresses used by a data link protocol. ARP operates below the network layer as a part of the OSI link layer and is defined by publications of the Internet Engineering Task Force (IETF), including a publication of the IETF Network Working Group entitled “An Ethernet Address Resolution Protocol—Converting Network Protocol Addresses to 48 Bit Ethernet Address for Transmission on Ethernet Hardware,” IETF publication RFC826, November 1982, which by this reference is. incorporated for all purposes.

In the present invention, ARP is used to determine the IP address-to-MAC address association. ARP is essentially the “glue” that ties these two addressing schemes together. For example, an application makes a request to read data from IP address 192.168.1.1. When this request hits the link layer, an ARP request is broadcasted to the local subnet to determine the physical MAC (Ethernet) address of the device which has the desired IP address. When the targeted machine sees the ARP request it will respond to the requester with its MAC address. When the client receives the ARP response, the packet is delivered over the Ethernet network to the Ethernet address of the device that has the associated IP address.

In the present invention ARP protocol and the IP-to-MAC address binding is used to allow clients to be distributed among several data access nodes, such as servers 212a, 212b, and 212c, with no additional hardware or software on the client side. In prior art systems clients are mapped to data access nodes or servers using specified IP addresses. Each server has its own unique IP address and MAC address. In order for the client to actually send the data to the server, the client needs to know the MAC address of the server that has the designated IP address. In prior art systems, when the client needs to resolve the desired IP address into its specific physical MAC address, it broadcasts an ARP request to all the servers on the subnet. Each server “listens” to these ARP requests and the server that has the desired IP address responds to the client, indicating his IP address and MAC address. The client then issues the original data over the physical network addressed to the MAC address of the server that has the requested IP address.

In the system of the present invention, the clients access data through a “pool IP address,” illustrated generally in FIG. 2A as IP address 192.168.1.100. This “pool IP address” does not directly correspond to a single server. Instead, it corresponds to a group of servers 212a, 212b, and 212c that will collectively determine which server has responsibility for responding to an ARP request. Each of the servers 212a, 212b, and 212c in the pool maintains a database of clients that they service. When the servers 212a, 212b, and 212c in the pool receive a broadcasted ARP request for the specified “pool IP address” they check their respective client service tables 216a, 216b, and 216c to determine if the sending client is one of the clients that they service. If a server determines that it is responsible for serving the client that sent the request, the server will send back an ARP response along with its MAC address. The client is then “bound” to the desired server in the pool and its subsequent requests will be sent to that specific server unless the server responsibilities are reallocated as discussed hereinbelow.

The clients can then be easily redistributed to different servers by modifying the client service table on the servers 212a, 212b, and 212c to control the load on each server. These tables can be pre-populated with clients or can be set up with an algorithm, such as a simple round-robin scheme, to assign servers as various clients make their requests. Also, the servers 212a, 212b, and 212c can continually monitor utilization levels, communicate with one another to determine the most beneficial distribution of clients, and modify their tables to redistribute the clients. This can be accomplished using load balancing algorithms that equalize the CPU utilization. For example, the servers can monitor the number of clients served by each server and reallocate clients to equalize the load. Alternatively, the servers can compare latency levels and CPU utilization and redistribute responsibility for serving clients to balance the load among the servers. This process does not occur for every request since the clients maintain an ARP cache. This process only occurs on the first transaction to a given IP address or when the ARP cache needs to be updated.

Operation of the present invention can be better understood from the following example:

1. A “Pool IP Address” is set up and servers 212a, 212b, and 212c are configured to “listen” to the given Pool IP address (e.g., 192.168.1.100).

Server 212a:

IP address: 192.168.1.5 (will hereinafter be referred to as “5” for discussion purposes)

MAC Address: 00-80-c6-fa-5f-8E (will hereinafter be referred to as “E” for discussion purposes)

Server 212b:

IP address: 192.168.1.6 (will hereinafter be referred to as “6” for discussion purposes)

MAC Address: 00-80-c6-fa-5f-8F (will hereinafter be referred to as “F” for discussion purposes)

Server 212c

IP address: 192.168.1.7 (will hereinafter be referred to as “7” for discussion purposes)

MAC Address: 00-80-c6-fa-5f-8G (will hereinafter be referred to as “G” for discussion purposes)

Pool IP address:

IP address: 192.168.1.100 (will hereinafter be referred to as “100” for discussion purposes)

2. Clients 210a, 201b, and 210c are mapped to the specified Pool IP Address for this pool (192.168.1.100 hereinafter “100” for discussion purposes)

Client 1:

IP address: 192.168.1.1 (will hereinafter be referred to as “1” for discussion purposes)

MAC Address: 00-80-c6-fa-5f-8a (will hereinafter be referred to as “a” for discussion purposes)

Client 2:

IP address: 192.168.1.2 (will hereinafter be referred to as “2” for discussion purposes)

MAC Address: 00-80-c6-fa-5f-8b (will hereinafter be referred to as “b” for discussion purposes)

Client 3:

IP address: 192.168.1.3 (will hereinafter be referred to as “3” for discussion purposes)

MAC Address: 00-80-c6-fa-5f-8c (will hereinafter be referred to as “c” for discussion purposes)

3. An application on Client 1 issues a read to the pool IP Address “100” as illustrated by the dashed transmission line 218 in FIG. 2B. The link layer on Client 1 issues an ARP request to determine the MAC address for the desired server.

4. Server 212a, Server 212b, and Server 212c see the ARP request and check their client service tables 216a, 216b, and 216c to determine if they are to service this client.

5. Server 212b determines that he is the requested server and therefore issues an ARP response back to Client 1 with his MAC address (“F”) as illustrated by the dashed line 220 in FIG. 2B.

6. Client 1 receives the ARP response and sends the read request to physical MAC address “F” (the address of Server 212b). Therefore Client 1 is bound to server 212b.

7. An application on Client 2 issues a read to the pool IP Address “100”. The link layer on Client 2 issues an ARP request to determine the MAC address for the desired server. (Transmission pathways similar to 218 and 220 discussed above exist for the following examples but are not explicitly shown)

8. Server 212a, Server 212b, and Server 212c see the ARP request and check their client service tables 216a, 216b, and 216c to determine if they are to service this client.

9. Server 212a determines that he is the requested server and therefore issues an ARP response back to Client 2 with his MAC address (“E”).

10. Client 2 receives the ARP response and sends the read request to physical MAC address “E” (the address of Server 212a). Therefore Client 2 is bound to Server 212a.

11. This same process happens for Client 3 and he is bound to Server 212a as well (at the time this is acceptable since the clients 210a, 201b, and 210c are not producing a heavy load).

12. The clients 210a, 201b, and 210c begin to produce a heavy load and Server 212a then becomes over utilized. A third server, “Server 212c”, is added and the client service tables 216a, 216b, and 216c are modified so that Client 3 will be bound to Server 212c on the next ARP request (either Client 3's ARP cache times out or Client 3 is remotely told by Server 212c to flush his ARP cache and re-ARP depending on implementation) .

Outcome:

Leveraging existing features in the established protocols on the client we can allow clients 210a, 201b, and 210c to be distributed and dynamically reallocated among available data access nodes (“servers 212a, 212b, and 212c”) to more evenly distribute client access load to alleviate bottlenecks or “hot spots”.

The client service tables 216a, 216b, and 216c on the servers 212a, 212b, and 212c can be pre-populated with which clients 210a, 201b, and 210c each server will service, or be populated as requests from clients 210a, 201b, and 210c arrive in to the pool using a user selectable algorithm (could be simple round-robin scheme or a more advanced scheme based on utilization levels, as will be understood by those skilled in the art).

The clients 210a, 201b, and 210c can be easily redistributed to different servers 212a, 212b, and 212c by modifying the client service tables 216a, 216b, and 216c on the servers 212a, 212b, and 212c to control the load on each server. This requires no additional software or manipulation on the client side.

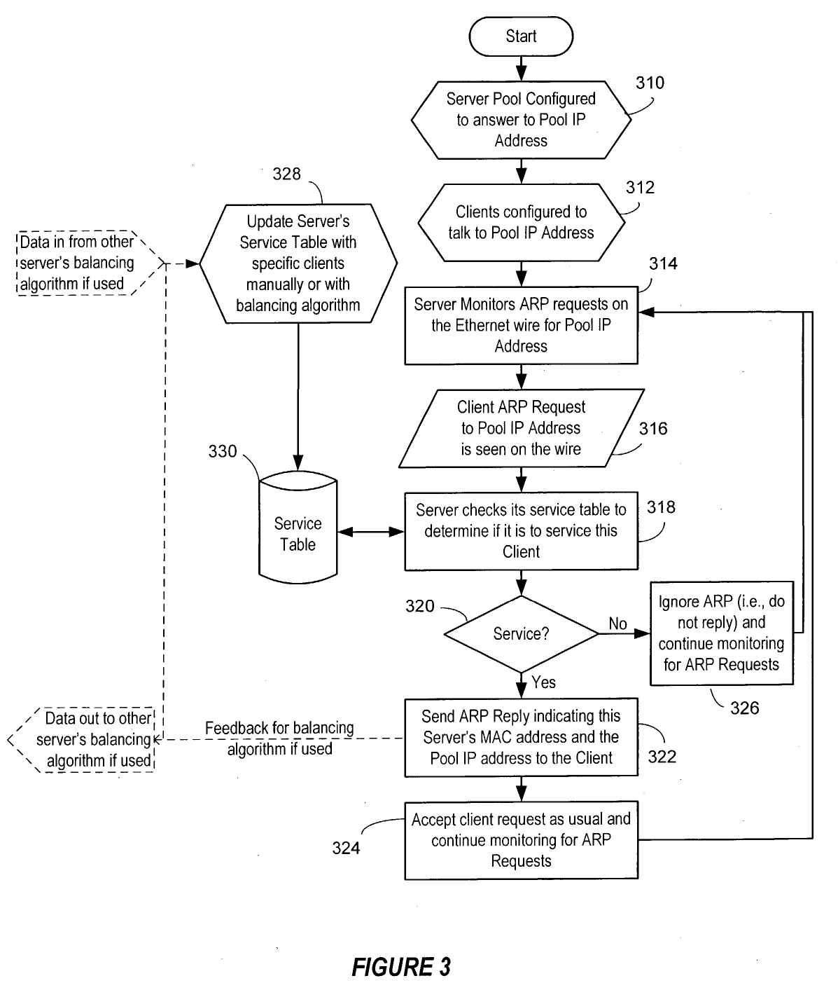

FIG. 3 is a flowchart illustration of the processing steps taken by the various servers 212a, 212b and 212c in accordance with the present invention. In step 310, the server pool is configured to respond to the Pool IP address and in step 312, the clients are configured to “talk” to the Pool IP address. In step 314, the servers monitor ARP requests transmitted over the network to the Pool IP address. In step 316, a client ARP request to the Pool IP address is detected on the network and, in step 318, each of the servers checks its service table to determine if the client sending the ARP request is contained in its respective service table. In step 320, each server determines whether it is responsible for servicing the ARP request. If the outcome of the step conducted in 320 is affirmative, processing proceeds to step 322 where the responsible server sends an ARP reply indicating that server's MAC address and the Pool IP address to the client. In step 324, the server accepts client requests as usual and continues monitoring for ARP requests and processing returns to step 314. If the result of the test conducted in step 320 indicates that the respective server is not responsible for servicing the ARP request, the ARP request is ignored and the server continues monitoring for other ARP requests and processing returns to step 314. As discussed previously, the service table 330 illustrated in FIG. 3 can be updated manually when the system is initialized or can be altered “on the fly” using a balancing algorithm as indicated in step 328. The balancing process can be accomplished through numerous techniques known in the art, including a simple round robin allocation algorithm or, alternatively, more sophisticated allocation algorithms based on performance such as CPU utilization.

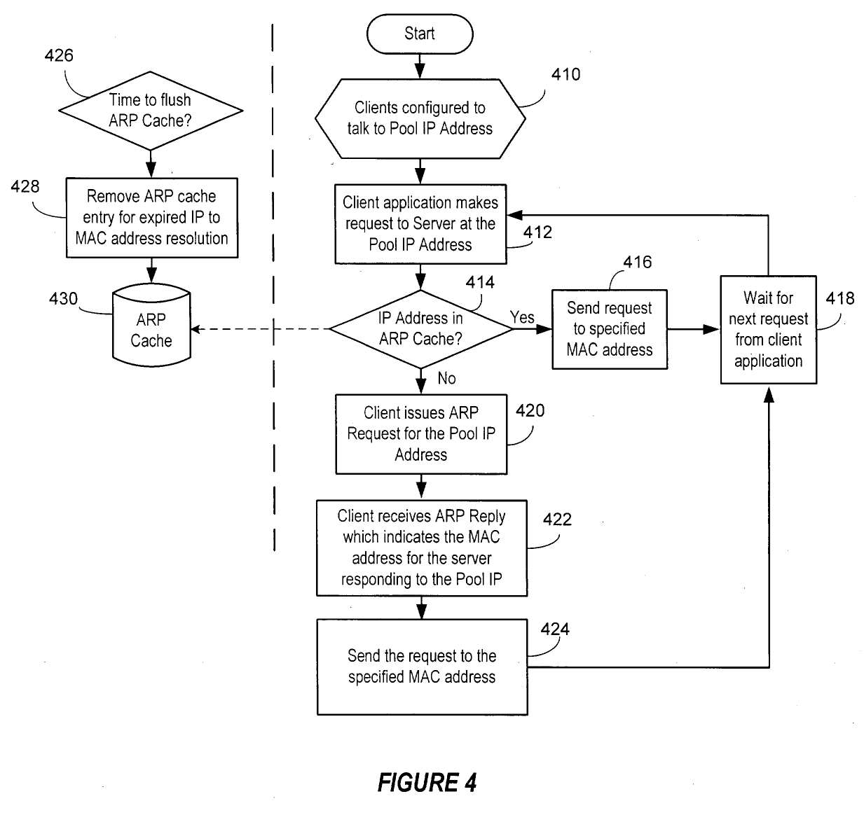

FIG. 4 is a flowchart illustration of the processing steps implemented by the clients 210a, 210b, and 210c in accordance with the present invention. In step 410, the clients are configured to communicate with the Pool IP address. In step 412, a client application makes a request to a server at the Pool IP address. In step 414, a test is conducted to determine whether the IP address resides in the ARP cache. If the result of the test in step 414 is affirmative, the request from the client application is sent to a specified MAC address in step 416 and the client waits for the next request at step 418 and then returns to step 412 for further processing. If the result of the test conducted in step 414 is negative, the client issues an ARP request to the Pool IP address in step 420. In step 422, the client receives an ARP reply which indicates the MAC address for the server responding to the Pool IP address. In step 424, the request is sent to the specified MAC address and the client proceeds to step 418 to wait for the next request and, then, returns to step 412 for further processing. Periodically, the client determines whether it is necessary to “flush” the ARP cache as indicated in step 426. If the test run in step 426 indicates that the ARP cache needs to be flushed, the ARP cache entries for expired IP-to-MAC address resolution is removed instep 428 and the ARP cache 330 is thus updated.

Using the method and apparatus of the present invention, clients can be easily redistributed to different servers by modifying the client service table on the various servers to control the load on each individual server. The present invention also provides a method and apparatus that allows the servers to continually monitor utilization levels, to communicate with one another to determine the most beneficial distribution of clients, and to modify their tables to redistribute the clients.

Although the present invention has been described in detail, it should be understood that various changes, substitutions and alterations can be made hereto without departing from the spirit and scope of the invention as defined by the appended claims.

What is claimed is:

1. A system for allocating the flow of information between a plurality of information handling systems, comprising:
a network having a pool network address corresponding to a plurality of servers;
a plurality of clients operable to broadcast requests to said pool network address, each of said plurality of clients further comprising:
a unique client network address corresponding to said client; and
a unique media access control address corresponding to said client;
a plurality of servers operable to detect broadcasts by said plurality of clients, each of said plurality of servers further comprising:
a unique address corresponding to said server; and
a unique media access control address corresponding to said server; and
wherein an individual server within said plurality of servers is operable to implement an automatic protocol to bind a specific client upon determining that said individual server is responsible for serving said client.

2. The system according to claim 1, wherein said network pool address comprises a pool internet protocol address.

3. The system according to claim 1, wherein said client network address and said server network address are internet protocol addresses.

4. The system according to claim 1, wherein said automatic protocol operates in the link layer of said network.

5. The system according to claim 4, wherein said automatic protocol comprises an address resolution protocol (ARP).

6. The system according to claim 1, wherein each of said servers further comprises a client service table corresponding to clients to be serviced by said server.

7. The system according to claim 6, wherein said individual server determines that it is responsible for serving said client by locating said client in a client service table.

8. The system according to claim 6, wherein responsibility of an individual server to serve a client can be modified by altering the contents of said client service table.

9. The system according to claim 6, wherein responsibility of an individual server to serve an individual client is determined by assigning individual clients to said client service tables using a round-robin protocol.

10. The system according to claim 6, wherein responsibility of an individual server to serve an individual client is determined by assigning individual clients to said client service tables using a performance-based protocol.

11. A method for allocating the flow of information between a plurality of clients and a plurality of servers in a network, comprising:
transmitting a request for service from at least one client to a pool network address;
monitoring said pool network address with a plurality of servers to detect said request for service from said client;
automatically binding an individual server to said client upon determining that said individual server is responsible for serving said client.

12. The method according to claim 11, wherein said pool network address comprises a pool internet protocol address.

13. The method according to claim 11, wherein said client and each of said plurality of servers have unique internet protocol addresses.

14. The method according to claim 11, wherein said automatic protocol operates in the link layer of said network.

15. The method according to claim 14, wherein said automatic protocol comprises automatic resolution protocol.

16. The method of claim 11, wherein each of said plurality of servers comprises a client service table corresponding to the clients to be serviced by a respective server.

17. The method according to claim 16, wherein said individual server determines that it is responsible for serving said client by locating said client in its client service table.

18. A system for allocating the flow of information between a plurality of clients and a plurality of servers, comprising:
means for transmitting a request for service from at least one client to a pool network address;
means for monitoring said pool network address with a plurality of servers to detect said request for service from said client;
means for automatically binding an individual server to said client upon determining that said individual server is responsible for serving said client.

19. The system according to claim 18, wherein said pool network address comprises a pool internet protocol address.

20. The system according to claim 18, wherein said client and each of said plurality of servers have unique internet protocol addresses.

21. The system according to claim 18, wherein said automatic protocol operates in the link layer of said network.

22. The system according to claim 21, wherein said automatic protocol comprises automatic resolution protocol.

23. The system of claim 18, wherein each of said plurality of servers comprises a client service table corresponding to the clients to be serviced by a respective server.

24. The system according to claim 23, wherein said individual server determines that it is responsible for serving said client by locating said client in its client service table.
